(19) United States
(12) Patent Application Publication
(10) Pub. No.: US 2021/0336774 A1
(43) Pub. Date: Oct. 28, 2021

(54) System for Secure Remote Access

(71) Applicant: Mark Kenneth Sullivan, Houston, TX (US)

(72) Inventor: Mark Kenneth Sullivan, Houston, TX (US)

(21) Appl. No.: 17/239,469

(22) Filed: Apr. 23, 2021

Related U.S. Application Data
(60) Provisional application No. 63/014,296, filed on Apr. 23, 2020.

(51) Int. Cl. H04L 9/08; H04L 9/30; H04L 9/06

(52) U.S. Cl. CPC H04L 9/0825; H04L 9/0631; H04L 9/3066; H04L 9/0841

(57) ABSTRACT

A system and method for providing secure encryption and a physical firewall between automated machines and a remote service terminal via an insecure public network.

### RELATED APPLICATIONS

This application claims priority to U.S. Provisional Application No. 63/014,296, filed Apr. 23, 2020.

### BACKGROUND OF THE INVENTION

Automated systems are all through the modern world. Manufacturing plants, warehouses, retail stores, power plants, water and wastewater plants, and transport infrastructure, to name a few all use automated control systems.

Before the Internet, the usual way to access a system was to physically travel to it. A small number of systems had remote access supported by expensive leased lines or by dial-up modems. But now, it is so easy to connect a control system to the public Internet, that the practice is ubiquitous in spite of significant risk of financial losses, loss of use of critical infrastructure, damage to property, and even loss of life.

Once a device connects to the Internet, the world potentially has access to it, which could lead to hacking or a compromised system. Furthermore, the systems and protocols for industrial automation were not originally designed with cyber security in mind. Most digital automation communication protocols were developed before the widespread use of the Internet. Major automation protocols such as Modbus TCP, Profinet, ControlNET, CIP, Foundation Fieldbus, and others do not have intrinsic security features. Security has to be added and this happens ad-hoc, if at all. There exists an ongoing need to securely access automated machinery at a remote location.

### BRIEF SUMMARY OF THE INVENTION

An example embodiment may include a system for the secure remote access from a first access device to a second digital electronic system which comprises two or more endpoint devices where the endpoint devices are equipped with connection ports compatible with the first terminal and the second system, the endpoint devices are connected to each other through remote communication means, and the endpoint devices have encryption means and encrypt the message on one end and decrypt it on the other such that the information is encrypted as it passes through the remote communications means.

A variation of the example embodiment may include the remote communication means being cell modems and a cellular telephone network. It may include the remote communication means being connected by each box to the public Internet. The encryption and decryption means may be embodied in digital hardware such as a field programmable gate array (FPGA). The encryption and decryption means may be embodied in digital hardware such as an application specific integrated circuit (ASIC). The encryption and decryption means may be embodied in a Harvard-architecture microcontroller with separate program and data memories. The encryption algorithm may be AES. The encryption keys may be established and shared via a public key cryptosystem. The public key cryptosystem may be a Diffie-Hellman key exchange. The public key cryptosystem may be an Elliptic Curve Diffie-Hellman key exchange. The devices may be portable and may be powered with an internal battery.

An example embodiment may include a system for the secure remote access from a first access device to a second digital electronic system which comprises at least one endpoint device, a first endpoint device adapted to couple a first terminal, an encryption device coupled to the first endpoint device, a second endpoint device adapted to couple to the encryption means and further coupled to a second terminal, wherein the encryption device physically couples the first endpoint device to the second endpoint device, and further wherein the first endpoint device can only communicate with the second endpoint device through the encryption device.

A variation of the example embodiment may include the first endpoint device being coupled to the internet. The second endpoint device may be coupled to a device employing a digital automation communication protocol. The encryption device may encrypt and decrypt data using a field programmable gate array (FPGA). The encryption device may encrypt and decrypt data using digital hardware such as an application specific integrated circuit (ASIC). The encryption device may encrypt and decrypt data using a Harvard-architecture microcontroller with separate program and data memories. The encryption device may use an advance encryption standard algorithm. The encryption keys may be established and shared via a public key cryptosystem. The public key cryptosystem may be a Diffie-Hellman key exchange. The public key cryptosystem may be an Elliptic Curve Diffie-Hellman key exchange.

### BRIEF DESCRIPTION OF THE SEVERAL VIEWS OF THE DRAWING

FIG. 1 depicts shows an embodiment of an example networked automated machine.

FIG. 2 depicts internal components of an example embodiment and the flow of data through it.

FIG. 3 depicts the process by which a pair of boxes and a central router establish communications.

FIG. 4 depicts the internal functionality of an encryption device utilizing a FPGA.

### DETAILED DESCRIPTION OF THE INVENTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims.

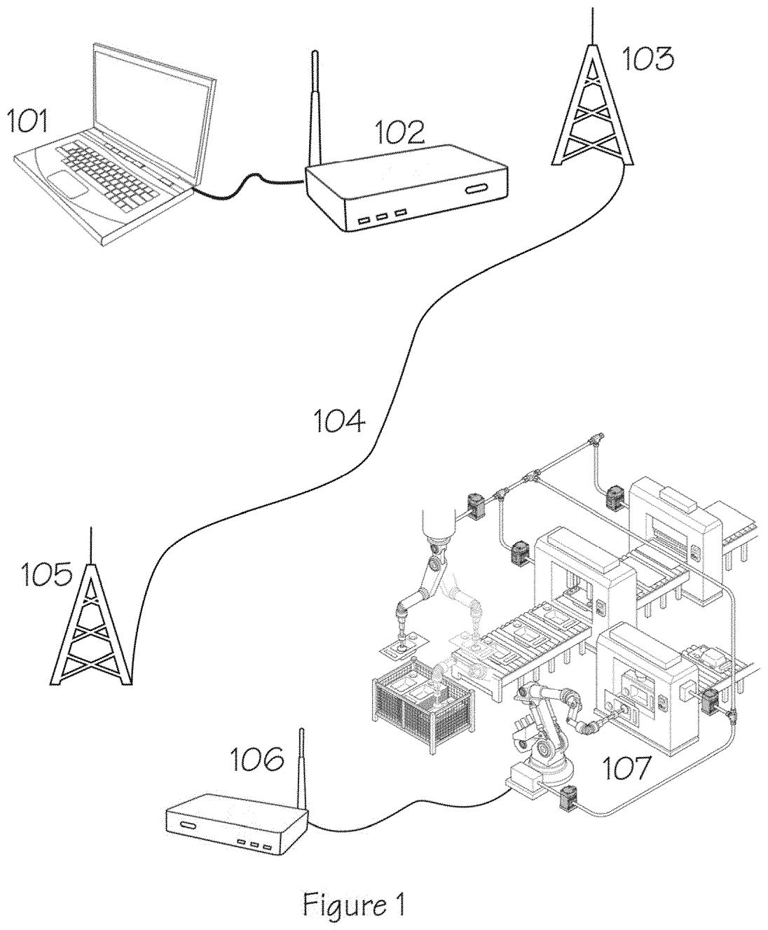

FIG. 1 shows an embodiment of an example networked automated machine. A personal computer is enabled to interact with a factory to monitor, control, and maintain automated machines. Software running on the computer 101 sends digital messages to remote box 102 which encrypts the data and sends it to a nearby cell tower 103. The encrypted message travels through the cell company's network 104 arriving at a second tower 105 close to the factory. Cell tower 105 sends the encrypted message to local box 106 which decrypts the message and restores it to the original form. The original message is then passed to an automated machine control 107.

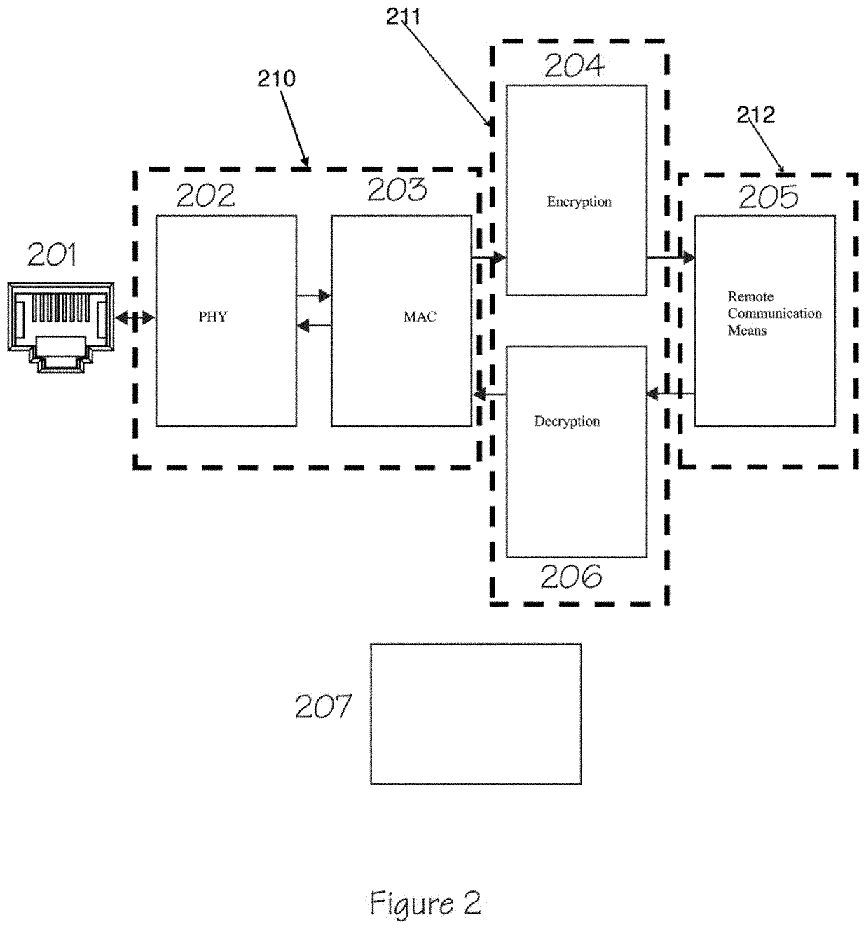

FIG. 2 illustrates the internal components of an example embodiment and the flow of data through it. These include a connector 201 compatible with a cable from the remote terminal and an access port on the protected system. Messages entering the port are processed by PHY 202 and MAC 203 which are common components of serial communications protocols. From MAC 202, messages pass to encryption means 204. The encryption means 204 performs the function of encrypting the base-band protocol messages. In an example embodiment, the encryption means should be a specific section of the hardware. Preferably, this section is implemented in a Field Programmable Gate Array (FPGA) or Application Specific Integrated Circuit (ASIC). Suitable FPGA devices are available from multiple manufacturers including Xilinx, Microchip Technology, Intel, Efinix, and others. Specific suitable FPGAs include the Xilinx part number XC7S25-2FTGB196C, Microchip part number MGL205-FGG484, and Efinix part number T20F256C3. In general, an FPGA with at least 20,000 logic cells will be sufficient to implement both the encryption and decryption means. In an alternate embodiment, the encryption means and decryption means could be implemented as firmware or software in an embedded microcontroller. In this case, a microcontroller with a Harvard architecture, with separate instruction and data memories, is preferred since it is more difficult for an attacker to change the stored program compared to a standard, Von Neuman architecture such as a conventional personal computer CPU. For maximum security, the encryption and decryption means must NOT be implemented as sections of software program running on the same computer hardware as the local or remote communication means.

Encrypted messages from 204 go on to remote communication means 205 from whence they are forwarded to the peer box. Messages from the peer box arrive in encrypted form via remote communication means 205 and are deciphered. The remote communication means transports the encrypted messages from each box to the other. The remote communication means comprises hardware and possibly software to transmit the encrypted messages to the peer station via an intermediary transmission medium. The transmission medium could be the public Internet, the switched public telephone network, a specific-purpose electrical or optical cable, specific-purpose radio signals, or shared radio signals in the form of a cellular communications network. The appropriate remote communication means will depend on the chosen transmission medium. For the public Internet, examples of suitable remote communications means include an Ethernet port, a WiFi radio, a DOCSIS cable modem, or a DSL modem. To use a cellular network as the transmission medium, suitable remote communication means could be a cellular data modem such as Multi-Tech Systems “MultiConnect eCell” or Telit part number LE910C4-NF.

The recovered original message passes through MAC 203 and PHY 202 and are output to the attached terminal or access port via connector 201. The MAC 203 and PHY 202 may form a physically connected internal communication device 210, the remote communication means 205 forma an external communication device 212, and the encryption means 204 and decryption means 206 form a physical barrier 211. Removal of physical barrier 211 disconnects the internal communication device 210 from the external communication device 212.

Control of internal operations of the box itself including instructing remote communication means to establish a connection, negotiating an encryption key with the peer box, and configuring encryption 204 and decryption means 206 are handled by controller 207 which is preferably a general-purpose microcontroller. Suitable microcontrollers include Microchip Technology part number ATSAMD51J18A, ST Microelectronics STM32F205ZET6, Silicon Labs part number EFM32LG980F256G. Implementation preferences and choices for the decryption means are the same as cited above for the encryption means. It is possible and preferable to implement both the encryption means and the decryption means in a single FPGA.

A power supply is not shown in the diagram. As anyone skilled in the art of electronics design will understand, a power supply must be selected or designed to deliver the voltages and currents required by the other components of the system. The exact choice of power supply, and whether to purchase it off-the-shelf or to design it as part of the system cannot therefore be made until choices are made for the FPGA or other device implementing the encryption and decryption means and the microcontrollers, modems, and communication modules implementing the remote communication means and the local connection MAC and PHY. However, a very common power standard for such systems is a nominal 3.3 volts DC. Suitable power supply means delivering sufficient current at 3.3 volts include Murata Power Systems part number OKI-78SR-3.3/1.5-W36H-C. For the example embodiment, the power supply means is supplied from a rechargeable battery such as a lithium-ion battery pack. An alternate embodiment might draw power from the AC mains or an external DC source (such as a vehicle) instead of an internal battery.

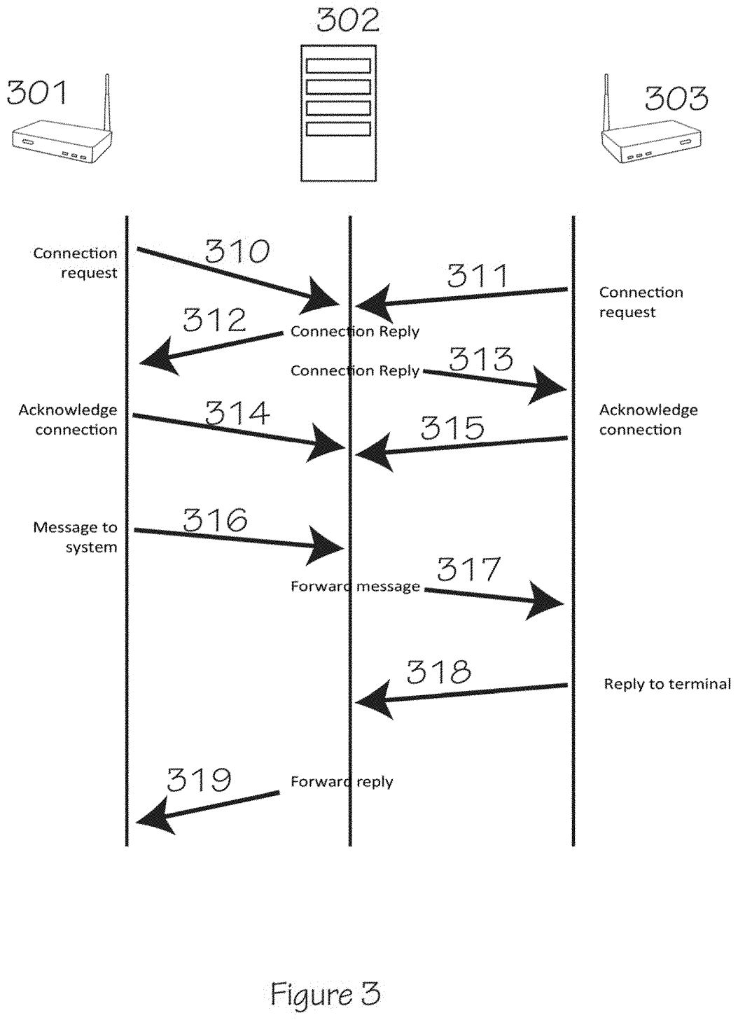

FIG. 3 illustrates the process by which a pair of boxes 301 and 303 and a central router 302 of the example embodiment establish communications. In the diagram, time runs from the top of the page to the bottom. Arrows show messages passing between the elements of the system.

When first turned on, each box independently sends a connection request 310 or 311 to the central router. Preferably, this connection request is for a TCP virtual circuit. From the message header, the central router obtains the network address of each box. The router sends each box a reply, 312 and 313 respectively, and receives acknowledgments 314 and 315. This connection process is between each box and the router. They do not have to be switched on at the same time.

Once both boxes are connected to the central router, they can negotiate encryption keys with each other. When either box sends a message, the router forwards it on to the peer box, using the address it learned in the connection process.

When the encryption keys have been negotiated, the boxes can begin to forward messages 316 from the remote terminal to the automated system and return a reply 318 back.

The function of the central router is only to forward the encrypted messages 316 and 318. Thus, the forwarded copies, 317 and 319 are the same as 316 and 318 except for addressing and routing information such as IP addresses and TCP port numbers.

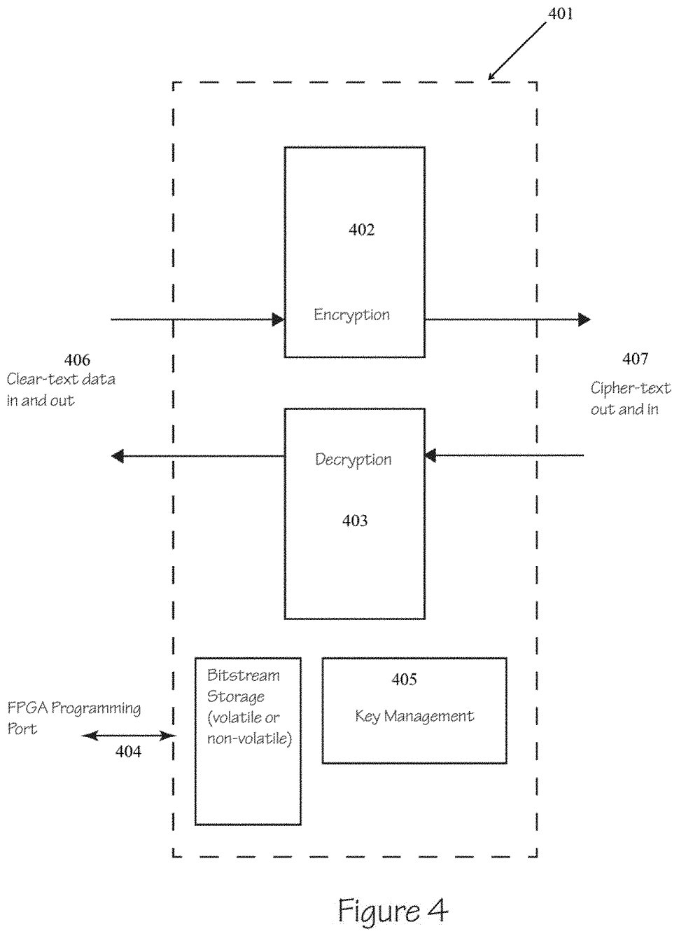

FIG. 4 shows the internal functionality of the FPGA 401 used in an example embodiment. Both encryption 402 of the clear-text data 406 and decryption 403 of the cipher-text data 407 are performed by the FPGA 401, although in different sections of the logic. Key management 405, preferably elliptic curve Diffie Hellman, is also implemented in the FPGA logic. FPGAs have a programming port 404 for loading the bitstream that instantiates the specific custom logic. Some FPGAs store a non-volatile record of the bitstream internally. Others require a separate memory from which the bitstream is loaded at every power-up. In the example embodiment there is no connection (either physical or wireless) between this programming port 404 and either the local interface port or the remote communication means. If there is a bitstream memory external to the FPGA, it must not be re-programmable via the remote communication means.

What is needed is a way to provide remote access to authorized people without providing access to those unauthorized. The next level of the problem is caused by authorized people inadvertently authorizing others. If the token for authorization is information, like a password, then it can be compromised. Many, if not most, ransomware attacks start with tricking an authorized person into revealing access credentials.

The invention is plurality of electronic devices. For purposes of understanding the invention, we will discuss a pair of such devices, but it should be understood that larger pluralities are not excluded.

The two devices embodied as boxes with internal electronics, a long-distance connection, such as the public Internet, between them, and connections for the protected system and the remote access interface. Commonly the service access port of an automated systems is a serial communications port, such as Ethernet, RS-232, RS-485, or USB. The access device is typically a personal computer such as a notebook or tablet computer although special purpose terminals are used. The terminal will have a communications port matching the automated system and a cable will be connected between them.

A set of embodiments of the invention are equipped with matching ports. The local box is connected to the automated system and the remote box is connected to the terminal, e.g. a personal computer. The function of the boxes is to transparently bridge the local and remote ports while securing the information passing between the two boxes.

In an example embodiment, the remote communications means between the two boxes is a cell phone network. Each box comprises a cellular modem enabling it to wirelessly send information, via the cell phone network and related infrastructure, to the peer box. In this example, the cell phone network plays the role of the central router. In an exemplary transaction, the remote terminal inputs a digital message into one box via its port. This message is then encrypted, and then the cipher is passed to the cell modem. The encrypted cipher is transported from one cell modem to the other via the cell network infrastructure. At the peer box, the cipher is emitted from the cell modem to the decryption means which reproduces the original digital information and transmits it out its port to the automated system. The opposite, symmetrical, pathway carries digital information from the automated system back to the terminal.

Exemplary of the prior art, Multi-Tech Systems “MultiConnect eCell” can pass digital information back and forth between an Ethernet port and a cell network, specifically an LTE network. Another prior-art device is the Moxa OnCell industrial LTE gateway.

In the prior art, the pairing of the boxes, i.e. the binding between two bridges is controlled by the cell service provider and can be changed dynamically. Therefore, an attacker with another such box, bought independently of the automated system management, could establish a connection with a target box. Further, the information from the Ethernet ports is not encrypted before passing it to the cell modem inside the eCell device. If transmissions are intercepted by a third party, the original digital information is easily recovered.

In contrast, an embodiment of the present invention encrypts the information within the boxes using keys that cannot be entered nor retrieved by a user of the box. In the example embodiment, the encryption means is digital hardware, not a processor running firmware or software. This hardware encryption and decryption means is preferably implemented in a field programmable gate array (FPGA) or application-specific integrated circuit (ASIC) and not in a general-purpose microprocessor. A key, novel, concept of the invention is the physical separation of local, clear-text and remote, encrypted messages via the interposing encryption and decryption means such that any compromise by an attacker cannot gain access to the unencrypted clear-text messages even if he obtains complete unfettered access to firmware or software running within or embodying the remote communication means. In an example embodiment with encryption and decryption means implemented in FPGA devices, it is essential that the programming terminals of the FPGA are not accessible to any of the microcontrollers in the other sections of the device. For maximum security, the only way to access the programing connections of the FPGA should be a connector within the device, used only for factory programming.

No matter how implemented, the two endpoints of an encrypted circuit must share a common key or a matching pair of asymmetrical keys. In the example embodiment, the hardware encryption means in the boxes use the Advanced Encryption Standard (AES) symmetrical cipher to encrypt the data and uses an augmented password authenticated key exchange (PAKE) to establish a shared key for the AES algorithm. In an example embodiment, the PAKE is implemented according to the International Telecommunication Union's recommendation X.1035. The term “password” in this case is a large secret number programmed into each box. Without this number, the PAKE doesn't create the same key in each box and the two will not be able to decrypt each other's messages. This is desirable as it prevents an attacker from posing as a valid remote access box. Because the main root cause of compromised systems is user's disclosing a password, a critical property of the example embodiment is that the user has no access to the large number serving as the generative password for the PAKE algorithm.

Implementation of the AES algorithm can be found in Federal Information Processing Standard publication 196.

In an alternate embodiment, the encryption means are programmed with a static, symmetrical, secret key. This raises the risk that the key can be disclosed by reverse engineering one box. However, this doesn't compromise security of other box pairs because there is no relationship between the keys used by different pairs. Such a physical attack does compromise the pair of boxes which were reverse-engineered, but physical access to one of the boxes means they are already compromised since the attacker can simply plug his computer into the box he has.

A key aspect of the example embodiment is that the pair of boxes act as a bridge. Digital messages entering a port on one box are emitted in whole and intact from the port of the second box. This is in contrast with conventional routers and WiFi access points where the computer and the remote system have to be configured to communicate with the router or access point. In a conventional Internet setup, the computer is assigned a local address by its router and the remote system has an address assigned by its local router. A certain amount of configuration on each end is required to establish a connection. Because the example embodiment does not interpret or modify the messages begin transported, the configuration of the computer and the automated system are exactly what they would be if the two were co-located and connected by a direct cable.

Routing and addressing are, of course, required in order for the encrypted data to be transported from one box to the other through the cell network. But these details need not concern a user of the boxes. Preferably, the boxes use a VPN within the cellular network, such as the Verizon “Private IP Wireless” service. However, the hardware encryption used in the example embodiment is secure enough for the encrypted messages to be transported over a public network.

Before two boxes can establish communications with one another and begin the process of generating a mutual encryption key, they must have each other's IP address. In some cellular networks, the modems get assigned routable IP addresses that can receive unsolicited packets from any other device knowing this address. In other cases, the address used by the modem is a local private IP address which is coupled to a public address via a Network Address Translation (NAT) process. The NAT enables a device to establish a connection to a known remote public address but does not necessarily allow a remote device to connect backwards through the NAT.

An example embodiment includes a central router system with public addresses. The central router serves to establish connectivity between the two boxes. This is necessary because the IP address of each box is otherwise not known to the other and might be a private address behind a NAT even if it was known. Each box establishes a virtual circuit with this router, rather than each other. The pairing of boxes is known to the central router and it passes messages from one box of a pair to the other and vice versa. If either box has a public address, the central router can simply advise the peer box of this address and the two boxes can communicate directly thereafter. If neither box has a public address, then all messages are sent to the central router and dispatched to the other box from there. It is important to note that, because the messages are encrypted in the boxes, the central router is not privy to the protected digital information. An attacker compromising the central router or the cell network still cannot recover the original messages. It is very important that the central router does NOT assign the encryption keys. The boxes must work together to establish this. If the central router has no knowledge of the keys, then it is intrinsically secure from disclosing a key and compromising communication between the boxes.

Clearly, the weak part of the proposed system of remote access control is that physical possession of a box gives one access to the protected asset. However, this doesn't make it an inferior solution for two reasons. Firstly, there is nothing preventing users of the box from using conventional software based security measures in addition to the security of the boxes. Secondly, and probably more important, a key challenge to cyber security is that it is poorly understood and that digital networks are complex and arcane. In contrast, physical security is easily understood and implemented—just lock up the box in a controlled location.

Ideally the boxes are only deployed when remote access is needed and not left connected permanently. This advice applies even more strongly to direct connections between automated systems and remote access terminals not using an embodiment of the invention but, in practice, this is rarely heeded. It is a goal of the invention that it be sufficiently convenient to disconnect the boxes that they are not left connected when not in use. It is intended that the boxes are physically secured when not in use.

Although the invention has been described in terms of embodiments which are set forth in detail, it should be understood that this is by illustration only and that the invention is not necessarily limited thereto. The alternative embodiments and operating techniques will become apparent to those of ordinary skill in the art in view of the present disclosure. Accordingly, modifications of the invention are contemplated which may be made without departing from the spirit of the claimed invention.

What is claimed:

1. An apparatus for the secure remote access to an access device of a digital electronic system comprising:
a first communication port adapted to couple to a remote communication means;
a second communication port coupled the first access device and the digital electronic system;
an encryption means that encrypts data communication passing between the first communication port and the second communication port;
a decryption means that decrypts data communication passing between the second communication port and the first communication port; and
a data port for programming the encryption means.

2. The system of claim 1 where the remote communication means is cell modems and a cellular telephone network.

3. The system of claim 1 where the remote communication means is by connecting each box to the public Internet.

4. The system of claim 1 where the encryption and decryption means are embodied in digital hardware such as a field programmable gate array.

5. The system of claim 1 where the encryption and decryption means are embodied in digital hardware such as an application specific integrated circuit.

6. The system of claim 1 where the encryption and decryption means are embodied in a Harvard-architecture microcontroller with separate program and data memories.

7. The system of claim 1 where the encryption algorithm is an advance encryption standard.

8. The system of claim 1 where the encryption keys are established and shared via a public key cryptosystem.

9. The system of claim 8 where the public key cryptosystem is a Diffie-Hellman key exchange.

10. The system of claim 8 where the public key cryptosystem is an Elliptic Curve Diffie-Hellman key exchange.

11. The portable endpoint devices of claim 1 where the devices are powered with an internal battery.

12. The system of claim 1 where the remote communication means is the public Internet and the devices are able to communicate with each other, even if they are assigned private addresses, by each connecting to a known, common, central router.

13. A system for the secure remote access a first network to a digital electronic system comprising:
a first endpoint device adapted to couple a first terminal;
an encryption device coupled to the first endpoint device;
a second endpoint device adapted to couple to the encryption means and further coupled to a second terminal;
wherein the encryption device physically couples the first endpoint device to the second endpoint device, and further wherein the first endpoint device can only communicate with the second endpoint device through the encryption device.

14. The system of claim 13 wherein the first endpoint device is coupled to the internet.

15. The system of claim 13 wherein the second endpoint device is coupled to a device employing a digital automation communication protocol.

16. The system of claim 13 wherein the encryption device encrypts and decrypts data using a field programmable gate array.

17. The system of claim 13 wherein the encryption device encrypts and decrypts data using digital hardware such as an application specific integrated circuit.

18. The system of claim 13 the encryption device encrypts and decrypts data using a Harvard-architecture microcontroller with separate program and data memories.

19. The system of claim 13 wherein the encryption device uses an advance encryption standard algorithm.

20. The system of claim 13 where the encryption keys are established and shared via a public key cryptosystem.

21. The system of claim 20 where the public key cryptosystem is a Diffie-Hellman key exchange.

22. The system of claim 20 where the public key cryptosystem is an Elliptic Curve Diffie-Hellman key exchange.
